(19) United States
(12) Patent Application Publication
(10) Pub. No.: US 2026/0192926 A1
(43) Pub. Date: Jul. 9, 2026

(54) AUTONOMOUS DE-ICING OF AERIAL VEHICLES

(71) Applicant: International Business Machines Corporation, Armonk, NY (US)

(72) Inventors: Adam Lee Griffin, Cohasset, MN (US); MARCO GERARDO VAZQUEZ MARTIN, Tepatitlán (MX); Amit Vachhani, Pune (IN); JOBY GEORGE CHERIAN, Jersey City, NJ (US); Priti P Patil, Wakad (IN)

(21) Appl. No.: 19/009,277

(22) Filed: Jan. 3, 2025

(51) Int. Cl. B64D 15/10; G05D 1/646; G05D 101/10; G05D 105/00; G05D 107/80; G06Q 10/0631; G06Q 10/20

(52) U.S. Cl. CPC B64D 15/10; G05D 1/646; G06Q 10/06311; G06Q 10/20; G05D 2101/10; G05D 2105/12; G05D 2107/85

(57) ABSTRACT

Autonomous de-icing includes receiving aviation facility data associated with an aviation facility, receiving vehicle data associated with each aerial vehicle of the plurality of aerial vehicles, and receiving fluid data associated with a fluid. An artificial intelligence (AI) model is applied on the aviation facility data, the vehicle data, and the fluid data to determine schedule data associated with a dispensing operation to be performed on at least one aerial vehicle of a plurality of aerial vehicles. Based on the schedule data and the fluid data, instructions data is generated. The instructions data includes a set of control instructions for the dispensing operation on the at least one aerial vehicle. Further, the instructions data is outputted.

### BACKGROUND

The disclosure relates to de-icing and more particularly, to autonomous de-icing of aerial vehicles.

De-icing is a process of removing ice, snow, and frost from the surface of the aerial vehicle to ensure the safe operation of the aerial vehicle and prevent damage or accidents. The accumulation of ice on the wings, and tail of the aerial vehicle may disrupt the flow of air over these surfaces, thereby leading to reduced lift, increased drag, and compromised control during operation. Therefore, the de-icing process in aviation is a critical process for aviation safety to ensure safe take-off and landing of the aerial vehicle. The de-icing is generally performed at de-icing areas, such as de-icing pads. Traditional practices of de-icing include manual scraping of the ice from the surface of the aerial vehicle or spraying de-icing fluids on the surface of the aerial vehicle. However, such traditional practices are time-consuming, cumbersome, resource-extensive, and subject to human errors.

### SUMMARY

In various embodiments of the disclosure, a computer-implemented method for generating instructions data for autonomous de-icing of aerial vehicles is described. The computer-implemented method includes receiving, by a computer, aviation facility data associated with an aviation facility. The aviation facility is associated with a plurality of aerial vehicles. The computer-implemented method further includes receiving, by the computer, vehicle data associated with each aerial vehicle of the plurality of aerial vehicles. The computer-implemented method further includes receiving, by the computer, fluid data associated with a fluid. The computer-implemented method further includes applying, by the computer, an artificial intelligence (AI) model on the aviation facility data, the vehicle data, and the fluid data. The computer-implemented method further includes determining, by the computer, schedule data associated with a dispensing operation of the fluid. The schedule data is determined based on the application of the AI model on the aviation facility data, the vehicle data, and the fluid data. The dispensing operation is performed on at least one aerial vehicle of the plurality of aerial vehicles. The computer-implemented method further includes generating, by the computer, instructions data based on the schedule data and the fluid data. The instructions data includes a set of control instructions for the dispensing operation on the at least one aerial vehicle. Further, the computer-implemented method includes outputting, by the computer, the instructions data.

In various embodiments of the disclosure, a computer system for generating instructions data for autonomous de-icing of aerial vehicles is described. The computer system includes a processor set, one or more computer-readable storage media, and program instructions stored on the one or more computer-readable storage media. The program instructions executable by the processor set further cause the processor set to receive aviation facility data associated with an aviation facility. The aviation facility is associated with a plurality of aerial vehicles. The program instructions further cause the processor set to receive vehicle data associated with each aerial vehicle of the plurality of aerial vehicles. The program instructions further cause the processor set to receive fluid data associated with a fluid. The program instructions further cause the processor set to apply an artificial intelligence (AI) model on the aviation facility data, the vehicle data, and the fluid data. The program instructions further cause the processor set to determine schedule data associated with a dispensing operation of the fluid. The schedule data is determined based on the application of the AI model on the aviation facility data, the vehicle data, and the fluid data. The dispensing operation is performed on at least one aerial vehicle of the plurality of aerial vehicles. The program instructions further cause the processor set to generate instructions data based on the schedule data and the fluid data. The instructions data includes a set of control instructions for the dispensing operation on the at least one aerial vehicle. Further, the program instructions cause the processor set to control a dispensing equipment based on the instructions data. The dispensing equipment is controlled based on the set of control instructions to perform the dispensing operation on the at least one aerial vehicle.

In various embodiments of the disclosure, a computer-program product for generating instructions data for autonomous de-icing of a plurality of aerial vehicles is described. The computer program product includes one or more computer-readable storage media, and program instructions stored on the one or more computer-readable storage media to perform operations including receiving aviation facility data associated with an aviation facility. The aviation facility is associated with the plurality of aerial vehicles. The operations further include receiving vehicle data associated with each aerial vehicle of the plurality of aerial vehicles. The operations further include receiving fluid data associated with a fluid. The operations further include applying an artificial intelligence (AI) model on the aviation facility data, the vehicle data, and the fluid data. The operations further include determining schedule data associated with the dispensing operation of the fluid. The schedule data is determined based on the application of the AI model on the aviation facility data, the vehicle data, and the fluid data. The dispensing operation is performed on at least one aerial vehicle of the plurality of aerial vehicles. The operations further include generating the instructions data based on the schedule data and the fluid data. The instructions data includes a set of control instructions for the dispensing operation on the at least one aerial vehicle. Further, the operations include outputting the instructions data.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for autonomous de-icing of aerial vehicles, in accordance with an embodiment of the disclosure;

FIG. 2 is a diagram that illustrates an environment for autonomous de-icing of aerial vehicles, in accordance with an embodiment of the disclosure;

FIG. 3 is a block diagram that illustrates an exemplary operation for autonomous de-icing of aerial vehicles, in accordance with an embodiment of the disclosure;

FIG. 4 is a diagram that illustrates the training of an artificial intelligence (AI) model for the determination of schedule data, in accordance with an embodiment of the disclosure;

FIG. 5 is a diagram that illustrates an exemplary scenario for controlling dispensing equipment for de-icing a plurality of aerial vehicles within an aviation facility, in accordance with an embodiment of the disclosure;

FIG. 6 is a block diagram that illustrates exemplary operations for autonomous de-icing of aerial vehicles, in accordance with an embodiment of the disclosure;

FIG. 7 is a diagram that illustrates a flow chart of an exemplary method for generating the instructions data for performing the dispensing operation, in accordance with an embodiment of the disclosure; and

FIG. 8 is a diagram that illustrates a flow chart of an exemplary method for autonomous de-icing of aerial vehicles, in accordance with an embodiment of the disclosure.

### DETAILED DESCRIPTION

With advancements in transportation, aerial vehicles have been a boon to mankind. The aerial vehicles have revolutionized transportation by enabling people and goods to travel vast distances quickly and efficiently. However, aerial vehicles face challenges in cold weather, particularly due to the formation of ice on their surface. When aerial vehicles fly through cold, moist air, a layer of ice forms on the surface of the aerial vehicles such as wings, and tail. Such formation of the ice disrupts the smooth airflow needed for aerodynamics, thereby increasing drag and reducing the lift of the aerial vehicles. For example, when the temperature of the atmosphere is below freezing point, moisture in the air or the surface of the aerial vehicle may condense upon contact therewith, thereby resulting in a thin coating or thick accumulation of the ice layer based on the environmental conditions and duration of exposure.

Traditionally specialized deicing fluids are applied on the surface of the aerial vehicle before takeoff to remove the existing ice, thereby ensuring the safe and reliable operation of the aerial vehicle. For example, specialized de-icing fluids (usually heated glycol) are used to remove ice and snow from the surface of the aerial vehicle. Such fluids are often heated and applied under pressure on the aerial vehicle to effectively break down and remove the frozen components and parts. The most common type of de-icing fluid is a mixture of water and glycol-based chemicals. The glycol in the fluid lowers the freezing point of the mixture, preventing further ice buildup and extending a holdover time. However, different chemical types may be considered for de-icing such as, but not limited to, ethylene glycol, propylene glycol, sodium formate, and potassium formate depending on the environmental conditions. For example, ethylene glycol is a clear, colorless, odorless liquid, thereby effective in melting ice and preventing ice reformation on the aerial vehicle. Alternatively, propylene glycol is less toxic and effective in melting ice, thereby preventing ice reformation on the aerial vehicle. For example, propylene glycol is often used in de-icing fluids for an aviation facility (such as an airport) located near environmentally sensitive areas. For example, sodium formate is used in combination with glycol-based fluids for de-icing. Alternatively, potassium formate is a type of de-icing chemical that is used in combination with glycol-based fluids. The sodium formate and the potassium formate are salts and are effective in melting ice and preventing ice reformation on the aerial vehicle. It is to be noted that the choice of the de-icing fluid and chemicals depends on a variety of factors such as the temperature, the weather conditions, the type of aerial vehicle, and the regulations and guidelines of the airport or aviation authority.

The de-icing process in the aviation industry is a critical process for aviation safety. The ice accumulation on the wings, tail, and remaining surfaces of the aerial vehicle may disrupt the flow of air over these surfaces, thereby leading to reduced lift, increased drag, and compromised control. In operation, de-icing fluid may be heated, and thereafter the heated de-icing fluid may be sprayed onto the aircraft's surfaces using specialized equipment, such as de-icing trucks or spray nozzles attached to a boom. The fluid is sprayed evenly across the wings, tail, fuselage, and remaining critical areas where ice accumulation may build. Conventionally, the de-icing fluids contain glycol, thereby having environmental impacts when they run into water sources and harm the soil. Further, the de-icing fluids and their application may pose health risks to workers and nearby communities. Moreover, exposure to the chemicals in these fluids may cause skin irritation, respiratory issues, and one or more health problems. Additionally, an incorrect application of de-icing fluids or using improper techniques may lead to damage to sensitive aircraft components, such as sensors, pitot tubes/airspeed sensors, antennas, and paint. Therefore, there is a need for proper communication operations, training for users who may be performing de-icing, and careful application to avoid causing damage to aircraft.

Further, the effectiveness of the type of fluids, volume applied, and environmental conditions of selected de-icing fluids are limited by their holdover time. The holdover time may be the time during which the de-icing fluids may prevent ice from re-forming on the aerial vehicles. If the aerial vehicle does not take off quickly, it may need to be de-iced again, causing additional delays, high expenditure, inconvenience to passengers, and logistical challenges. Additionally, weather and mandatory de-icing processes may cause delays in flight schedules. Moreover, airports may not always have sufficient de-icing equipment and trained personnel available to handle the de-icing needs of multiple aircraft during challenging weather conditions. Therefore, insufficient equipment or personnel may lead to delays and operational disruptions. To overcome such a multitude of challenges associated with the de-icing process, thereby resulting in larger issues, damage, or accidents if not mitigated or managed properly. Therefore, there is a need to develop a system and method for a data-driven aviation industry management platform in autonomous de-icing equipment and fleet operation to render greater efficiencies in airports and airlines across the world.

The disclosed system uses datasets to optimize de-icing fleet task performance while prioritizing tasks (de-icing) based on selected datasets, and/or a set of rules/preferences defined in personalized airport corpus/profiled attributes. For example, the disclosed system may employ data associated with the aviation facility, the aerial vehicle, and the de-icing fluid to optimize the de-icing fleet task performance by generating a set of control instructions for a dispensing operation of the de-icing fluid on the aerial vehicle. Such data may be crucial in the prioritizing of the aerial vehicle for the dispensing operation, selection of the appropriate fluid for the dispensing operation, determination of time required and a volume of fluid required for the dispensing operation, thereby optimizing the de-icing fleet task.

Further, the disclosed system is designed to automatically and dynamically prioritize the de-icing of the aerial vehicle based on various factors (such as a departure time of the aerial vehicle, or a priority of the aerial vehicle), thereby mitigating manual intervention that was required in the conventional approaches. Furthermore, the disclosed system avoids re-de-icing of the aerial vehicle, thereby utilizing the time efficiently. Further, the system performs deicing of the aerial vehicle, thereby providing thorough cleaning of the aerial vehicle. Further, the system may be designed to leverage the data-driven aviation system management platform to influence factors such as inclement weather, external up/downstream schedule disruptions, schedule delays, re-routed aircraft, mishaps & emergency scenarios, etc. to manage and optimize the most efficient in/out de-ice prioritization means as possible. For example, the system may be designed to leverage the artificial intelligence to determine schedule data associated with the dispensing operation. Additionally, the system may be designed to develop personalized airport attribute/profile assignments via customizable methods to be utilized within autonomous de-icing equipment to render greater efficiencies in airports and airlines across the world.

In various embodiments of the disclosure, a computer-implemented method for generating instructions data for autonomous de-icing of aerial vehicles is described. The computer-implemented method includes receiving, by a computer, aviation facility data associated with an aviation facility. The aviation facility is associated with a plurality of aerial vehicles. The computer-implemented method further includes receiving, by the computer, vehicle data associated with each aerial vehicle of the plurality of aerial vehicles. The computer-implemented method further includes receiving, by the computer, fluid data associated with a fluid. The computer-implemented method further includes applying, by the computer, an artificial intelligence (AI) model on the aviation facility data, the vehicle data, and the fluid data. The computer-implemented method further includes determining, by the computer, schedule data associated with a dispensing operation of the fluid. The schedule data is determined based on the application of the AI model on the aviation facility data, the vehicle data, and the fluid data. The dispensing operation is performed on at least one aerial vehicle of the plurality of aerial vehicles. The computer-implemented method further includes generating, by the computer, instructions data based on the schedule data and the fluid data. The instructions data includes a set of control instructions for the dispensing operation on the at least one aerial vehicle. Further, the computer-implemented method includes outputting, by the computer, the instructions data.

In various embodiments of the disclosure, the aviation facility data includes flight schedule data associated with each aerial vehicle of the plurality of aerial vehicles, location data associated with the aviation facility, weather data associated with the aviation facility, layout data associated with the aviation facility, and air traffic data associated with the aviation facility.

In various embodiments of the disclosure, the computer-implemented method further includes determining, by the computer, holdover time data associated with each aerial vehicle of the plurality of aerial vehicles based on the application of the AI model on the aviation facility data, the vehicle data, and the fluid data. The computer-implemented method further includes determining, by the computer, the schedule data associated with the dispensing operation based on the holdover time data.

In various embodiments of the disclosure, the computer-implemented method further includes controlling, by the computer, a dispensing equipment based on the instructions data. The dispensing equipment is controlled based on the set of control instructions to perform the fluid dispensing operation on the at least one aerial vehicle.

In various embodiments of the disclosure, the dispensing equipment is an autonomous vehicle. The set of control instructions includes at least one of a set of navigation instructions for a navigation of the dispensing equipment with respect to the at least one aerial vehicle, a set of adjustment instructions for adjusting the dispensing equipment for performing the dispensing operation, or a set of operation instructions for performing the dispensing operation.

In various embodiments of the disclosure, the computer-implemented method further includes receiving, by the computer, equipment data associated with the dispensing equipment. The equipment data includes aperture data associated with the dispensing equipment and flow data associated with a flow of the fluid for the dispensing operation. The computer-implemented method further includes applying, by the computer, the AI model on the equipment data. The computer-implemented method further includes determining, by the computer, the schedule data based on the application of the AI model.

In various embodiments of the disclosure, the computer-implemented method further includes receiving, by the computer, sensor data from one or more sensors. Each sensor of the one or more sensors is associated with the at least one aerial vehicle. The computer-implemented method further includes generating, by the computer, status data based on the sensor data. The status data is associated with the dispensing operation of the fluid from the dispensing equipment on the at least one aerial vehicle. The computer-implemented method further includes outputting, by the computer, the status data.

In various embodiments of the disclosure, the fluid data includes a chemical composition associated with the fluid, a density of the fluid, and a volume of the fluid in the dispensing equipment.

In various embodiments of the disclosure, the vehicle data associated with each aerial vehicle of the plurality of aerial vehicles includes a type of an aerial vehicle, a model number associated with the aerial vehicle, a dimension of the aerial vehicle, and one or more available sensors associated with the aerial vehicle.

In various embodiments of the disclosure, the aviation facility is associated with a plurality of dispensing equipment. The computer-implemented method further includes applying, by the computer, the AI model on the schedule data associated with the dispensing operation, the aviation facility data, the vehicle data, and the fluid data. The computer-implemented method further includes determining, by the computer, equipment schedule data associated with each dispensing equipment of the plurality of dispensing equipment based on the application of AI model the schedule data associated with the dispensing operation, the aviation facility data, the vehicle data, and the fluid data. The computer-implemented method further includes generating, by the computer, the instructions data for each dispensing equipment of the plurality of dispensing equipment based on the equipment schedule data.

In various embodiments of the disclosure, the computer-implemented method further includes receiving, by the computer, training dataset including historical vehicle data, historical aviation facility data, historical fluid data, and historical schedule data. The computer-implemented method further includes training, by the computer, the AI model based on the training dataset. The computer-implemented method further includes applying, by the computer, the trained AI model on the aviation facility data, the vehicle data, and the fluid data. The computer-implemented method further includes determining, by the computer, the schedule data associated with the dispensing operation based on the application of the trained AI model.

In various embodiments of the disclosure, the schedule data indicates a schedule for sustaining a flow of the fluid for the dispensing operation on a specific aerial vehicle of the at least one aerial vehicle. The schedule data includes at least one of a start time for the dispensing operation, an end time for the dispensing operation, or one or more dispensing parameters associated with the flow of the fluid.

In various embodiments of the disclosure, a computer system for controlling robots for a computer system for generating instructions data for autonomous de-icing of aerial vehicles is described. The computer system includes a processor set, one or more computer-readable storage media, and program instructions stored on the one or more computer-readable storage media. The program instructions executable by the processor set further cause the processor set to receive aviation facility data associated with an aviation facility. The aviation facility is associated with a plurality of aerial vehicles. The program instructions further cause the processor set to receive vehicle data associated with each aerial vehicle of the plurality of aerial vehicles. The program instructions further cause the processor set to receive fluid data associated with a fluid. The program instructions further cause the processor set to apply an artificial intelligence (AI) model on the aviation facility data, the vehicle data, and the fluid data. The program instructions further cause the processor set to determine schedule data associated with a dispensing operation. The schedule data is determined based on the application of the AI model the aviation facility data, the vehicle data, and the fluid data. The dispensing operation is performed on at least one aerial vehicle of the plurality of aerial vehicles. The program instructions further cause the processor set to generate instructions data based on the schedule data and the fluid data. The instructions data includes a set of control instructions for the dispensing operation on the at least one aerial vehicle. Further, the program instructions cause the processor set to control a dispensing equipment based on the instructions data. The dispensing equipment is controlled based on the set of control instructions to perform the dispensing operation on the at least one aerial vehicle.

In various embodiments of the disclosure, the aviation facility data includes flight schedule data associated with each aerial vehicle of the plurality of aerial vehicles, location data associated with the aviation facility, weather data associated with the aviation facility, layout data associated with the aviation facility, and air traffic data associated with the aviation facility.

In various embodiments of the disclosure, the program instructions cause the processor set to determine holdover time data associated with each aerial vehicle of the plurality of aerial vehicles based on the application of the AI model on the aviation facility data, the vehicle data, and the fluid data. The program instructions cause the processor set to determine the schedule data associated with the dispensing operation based on the holdover time data.

In various embodiments of the disclosure, the dispensing equipment is an autonomous vehicle. The set of control instructions includes at least one of a set of navigation instructions for a navigation of the dispensing equipment with respect to the at least one aerial vehicle, a set of adjustment instructions to adjust the dispensing equipment for the performing the dispensing operation, or a set of operation instructions for the performing the dispensing operation.

In various embodiments of the disclosure, the program instructions cause the processor set to receive equipment data associated with the dispensing equipment. The equipment data includes aperture data associated with the dispensing equipment and flow data associated with a flow of the fluid for the dispensing operation. The program instructions cause the processor set to apply the AI model on the equipment data. The program instructions cause the processor set to determine the schedule data based on the application of the AI model.

In various embodiments of the disclosure, the program instructions cause the processor set to receive sensor data from one or more sensors. Each sensor of the one or more sensors is associated with the at least one aerial vehicle. The program instructions cause the processor set to generate status data based on the sensor data. The status data is associated with the dispensing operation of the fluid from the dispensing equipment on the at least one aerial vehicle and outputs the status data.

In various embodiments of the disclosure, the aviation facility is associated with a plurality of dispensing equipment. The program instructions cause the processor set to apply the AI model to the schedule data associated with the dispensing operation, the aviation facility data, the vehicle data, and the fluid data. The program instructions cause the processor set to determine equipment schedule data associated with each dispensing equipment of the plurality of dispensing equipment based on the application of the AI model on the schedule data associated with the dispensing operation, the aviation facility data, the vehicle data, and the fluid data. The program instructions cause the processor set to generate the instructions data for each dispensing equipment of the plurality of dispensing equipment based on the equipment schedule data.

In various embodiments of the disclosure, a computer-program product for generating instructions data for autonomous de-icing of a plurality of aerial vehicles is described. The computer program product includes one or more computer-readable storage media, and program instructions stored on the one or more computer-readable storage media to perform operations including receiving aviation facility data associated with an aviation facility. The aviation facility is associated with a plurality of aerial vehicles. The operations further include receiving vehicle data associated with each aerial vehicle of the plurality of aerial vehicles. The operations further include receiving fluid data associated with a fluid. The operations further include applying an artificial intelligence (AI) model on the aviation facility data, the vehicle data, and the fluid data. The operations further include determining schedule data associated with the dispensing operation of the fluid. The schedule data is determined based on the application of the AI model the aviation facility data, the vehicle data, and the fluid data. The dispensing operation is performed on at least one aerial vehicle of the plurality of aerial vehicles. The operations further include generating the instructions data based on the schedule data and the fluid data. The instructions data includes a set of control instructions for the dispensing operation on the at least one aerial vehicle. Further, the operations include outputting, by the computer, the instructions data.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the generate of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

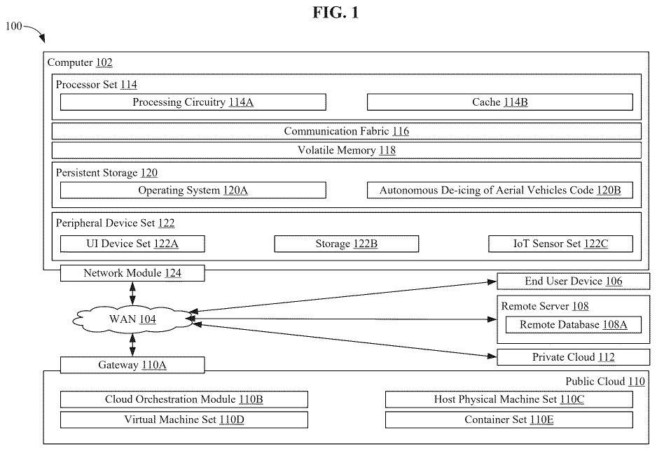

FIG. 1 is a diagram that illustrates a computing environment 100 for autonomous de-icing of aerial vehicles, in accordance with an embodiment of the disclosure. The diagram contains an exemplary environment for the execution of at least one module involved in performing the methods, such as an autonomous de-icing of aerial vehicles code 120B associated with generating deployment data for machines based on simulations. In addition to autonomous de-icing of aerial vehicles code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the autonomous de-icing of aerial vehicles code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or various wearable computer, a mainframe computer, a quantum computer, or any various form of a computer or a mobile device now known or to be developed in the future that may run a program, access a network or query a database, such as a remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though it is not shown in a cloud in FIG. 1. In an additional embodiment, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the various storage media discussed below. The program instructions, and associated data, are accessed by the processor set 114 to control and direct the performance of the methods. In computing environment 100, at least some of the instructions for performing the methods may be stored in the autonomous de-icing of aerial vehicles code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The autonomous de-icing of aerial vehicles code 120B typically includes at least one module involved in performing the methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with different computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the methods can typically be downloaded to computer 102 from an external computer or external storage device through a network adapter card or network interface included in the network module 124.

The WAN 104 is any wide area network (for example, the internet) configured to communicate computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments (VCEs) that run on various computers making up the computers of the host physical machine set 110C, which is the universe of physical computers in and/or available to the public cloud 110. The VCEs typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of diverse types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

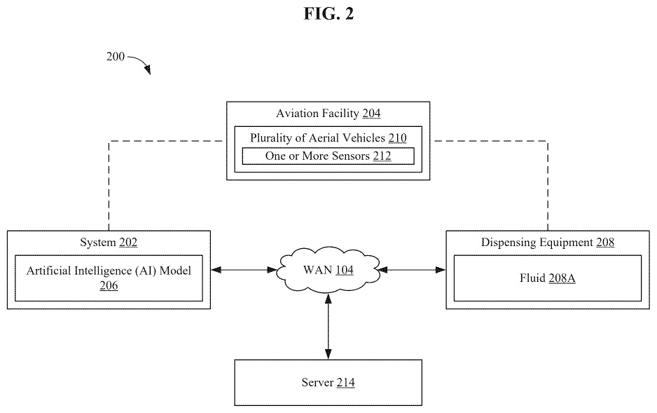

FIG. 2 is a diagram that illustrates an environment for autonomous de-icing of aerial vehicles, in accordance with an embodiment of the disclosure. FIG. 2 is explained in conjunction with elements from FIG. 1. With reference to FIG. 2, there is shown a diagram of a network environment 200. The network environment 200 includes a system 202 (also referred to as a computer system) that may be associated with an aviation facility 204, an artificial intelligence (AI) model 206, and a dispensing equipment 208. The aviation facility 204 hosts a plurality of aerial vehicles 210. Further, the network environment 200 also includes a server 214. The network environment 200 further includes the WAN 104 of FIG. 1. In an embodiment, the system 202 is an exemplary embodiment of the computer 102 in FIG. 1.

The system 202 includes suitable logic, circuitry, and/or interfaces for autonomous de-icing of aerial vehicles. The system 202 is configured to receive aviation facility data associated with the aviation facility 204 associated with the plurality of aerial vehicles 210. The system 202 is further configured to receive vehicle data associated with each aerial vehicle of the plurality of aerial vehicles 210. The system 202 is further configured to receive fluid data associated with fluid 208A. The system 202 is further configured to apply the AI model 206 on the aviation facility data, the vehicle data, and the fluid data. The system 202 is further configured to determine schedule data associated with a dispensing operation of the fluid 208A. The schedule data is determined based on the application of the AI model 206 the aviation facility data, the vehicle data, and the fluid data. The dispensing operation is performed by the dispensing equipment 208 on at least one aerial vehicle of the plurality of aerial vehicles 210. The system 202 is further configured to generate instructions data based on the schedule data and the fluid data. The instructions data includes a set of control instructions for the dispensing operation on the at least one aerial vehicle. The system 202 is further configured to output the instructions data.

The aviation facility 204 may refer to a specified physical zone or an infrastructure that supports the operation, maintenance, and management of the plurality of aerial vehicles 210 and the one or more aviation activities associated therewith. Different types of aviation facilities may include, but are not limited to, an airport, a heliport, a maintenance hangar, a fueling station, a flight school, and a cargo terminal. An airport is a hub that provides runways, terminals, and various services for passengers and the plurality of aerial vehicles 210. The heliport is a designated area for the landing and takeoff of helicopters (a type of aerial vehicle). The maintenance hangar facilities are dedicated to the repair and maintenance of the plurality of aerial vehicles 210. The fueling stations correspond to a location where the plurality of aerial vehicles 210 can refuel. The flight school corresponds to an institution that provides training for pilots and various aviation professionals. The cargo terminal corresponds to a facility that is specifically designed for the handling of freight and cargo transportation by air.

Each aerial vehicle of the plurality of aerial vehicles 210 is a machine or a device that may be designed to travel through the atmosphere or space, primarily for transportation, surveillance, research, or recreation. The plurality of aerial vehicles 210 may be categorized into several types based on their design and function. Different types of aerial vehicles include, but are not limited to, a fixed-wing aircraft, a rotary-wing aircraft, an unmanned aerial vehicles (UAVs), a glider, a sailplane, and an airship. Examples of the plurality of aerial vehicles 210 include, but are not limited to an airplane, a cargo plane, a helicopter, a rotorcraft, or a drone.

The AI model 206 may be a computational network or a system of artificial neurons, arranged in a plurality of layers, as nodes. The plurality of layers of the AI model 206 may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in various layers of the AI model 206. Outputs of each hidden layer may be coupled to inputs of at least one node in various layers of the AI model 206. Node(s) in the final layer may receive inputs from at least one hidden layer to output a result. The number of layers and the number of nodes in each layer may be determined from the hyper-parameters of the AI model 206. Such hyper-parameters may be set before or while training the AI model 206 on a training dataset.

Each node of the AI model 206 may correspond to a mathematical function (e.g., a sigmoid function or a rectified linear unit) with a set of parameters, tunable during the training of the network. The set of parameters may include, for example, a weight parameter, a regularization parameter, and the like. Each node may use the mathematical function to compute an output based on one or more inputs from nodes in different layer(s) (e.g., previous layer(s)) of the AI model 206. All or some of the nodes of the AI model 206 may correspond to the same or a different mathematical function.

In training the AI model 206, one or more parameters of each node of the AI model 206 may be updated based on whether an output of the final layer for a given input (from the training dataset) matches a correct result based on a loss function for the AI model 206. The above process may be repeated for the same or a different input until a minimum loss function may be achieved, and a training error may be minimized. Several methods for training are known in the art, for example, gradient descent, stochastic gradient descent, batch gradient descent, gradient boost, meta-heuristics, and the like.

The AI model 206 may include electronic data, such as, for example, a software program, code of the software program, libraries, applications, scripts, or logic or instructions for execution by a processing device, such as circuitry. The AI model 206 may include code and routines configured to enable a computing device, such as the system 202, to perform one or more operations. Additionally, or alternatively, the AI model 206 may be implemented using hardware including a processor, a microprocessor (e.g., to perform or control the performance of one or more operations), a field-programmable gate array (FPGA), or an application-specific integrated circuit (ASIC). Alternatively, in some embodiments, the AI model 206 may be implemented using a combination of hardware and software. Although in FIG. 1, the AI model 206 is shown integrated within the system 202, the disclosure is not so limited. Accordingly, in some embodiments, the AI model 206 may be a separate entity in the system 202, without deviation from the scope of the disclosure. In an embodiment, the AI model 206 may be stored in the server 214. Examples of the AI model 206 may include, but are not limited to, a deep neural network (DNN), a convolutional neural network (CNN), a CNN-recurrent neural network (CNN-RNN), R-CNN, Fast R-CNN, Faster R-CNN, an artificial neural network (ANN), (You Only Look Once) YOLO network, a fully connected neural network, and/or a combination of such networks.

The dispensing equipment 208 may be a semi-autonomous vehicle, or a fully autonomous vehicle, for example, as defined by the National Highway Traffic Safety Administration (NHTSA) that may have a nozzle to dispense the fluid on the plurality of aerial vehicles 210. Examples of the dispensing equipment 208 may include, but are not limited to, a hybrid vehicle, or an autonomous vehicle that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by various forms of alternative energy sources.

Each sensor of the one or more sensors 212 may include suitable logic, circuitry, interfaces, and/or code that are configured to capture sensor data and may further transmit the captured sensor data to the system 202. The sensor data may be transmitted over the WAN 104 to the system 202. Each sensor of the one or more sensors is associated with the at least one aerial vehicle of the plurality of aerial vehicles 210. The one or more sensors 212 may collect real-time data to detect ice or layers of ice on the surface of the plurality of aerial vehicles 210. The real-time data is processed by the system 202 to detect the formation of the ice on the corresponding aerial vehicle. The one or more sensors 212 includes, but may not be limited to, a temperature sensor, a moisture sensor, an ultrasonic sensor, an imaging sensor, an acoustic sensor, a conductivity sensor, a Radio Detection And Ranging (RADAR) sensor, a Light Detection and Ranging (LiDAR) sensor, and an optical sensor. The temperature sensors, such as thermocouples or resistance temperature detectors (RTDs), may detect temperature changes that indicate the presence of ice. The formation of ice typically causes a drop in temperature, which may be measured by the temperature sensors. The moisture sensors, such as capacitive or resistive sensors, may detect the presence of water or ice by measuring changes in the moisture content of a material or environment. The formation of ice introduces moisture, which may be detected by these sensors. The ultrasonic sensors emit high-frequency sound waves and measure the time it takes for the waves to bounce back after hitting an object. When ice is present on the object, the ultrasonic waves may reflect differently compared to materials apart from ice. Such materials may include, but not limited to, a metal surface, a rubber surface, or a plastic surface. This may allow the sensor to detect the presence of ice on the object. The imaging sensors, such as infrared cameras or thermal imaging cameras, may detect temperature differences and provide visual representations of objects or the surface of the aerial vehicle. The imaging sensors may be used to identify areas where ice has formed based on temperature variations. The acoustic sensors may detect the acoustic signature of ice formation or ice movement. The acoustic sensors may pick up sounds or vibrations generated by ice formation, cracking, or movement, allowing for the detection of ice layers. The conductivity sensors measure the electrical conductivity of a substance or medium. When ice forms, it generally has lower conductivity compared to materials apart from ice. Such materials may include, but not limited to a metal object, or a plastic object, which may be detected by the conductivity sensors. The RADAR and LiDAR sensors use electromagnetic waves to detect objects and measure their distance and characteristics. These sensors may identify the presence of ice or ice layers based on the different reflection or scattering patterns of the waves when the waves encounter ice surfaces. The optical sensors, such as cameras or light-based sensors, may be used to visually detect the presence of ice or snow by analyzing the changes in reflection or scattering of light resulted from the frozen precipitation.

The server 214 may include suitable logic, circuitry, and interfaces, and/or code that may be configured to store the aviation facility data, the vehicle data, and the fluid data. The server 214 may be further configured to store the instructions data. In some embodiments, the server 214 may be further configured to store holdover time data associated with each aerial vehicle of the plurality of aerial vehicles 210 and equipment data associated with the dispensing equipment 208. In an embodiment, the server 214 may store the AI model 206. The server 214 may be implemented as a cloud server and may execute operations through web applications, cloud applications, HTTP requests, repository operations, file transfer, and the like. Additional example implementations of the server 214 may include, but are not limited to, a database server, a file server, a web server, a media server, an application server, a mainframe server, or a cloud computing server.

In at least one embodiment, the server 214 may be implemented as a plurality of distributed cloud-based resources by use of several technologies that are well known to those ordinarily skilled in the art. A person with ordinary skill in the art will understand that the scope of the disclosure may not be limited to the implementation of the server 214 and the system 202 as two separate entities. In certain embodiments, the functionalities of the server 214 can be incorporated in its entirety or at least partially in the system 202, without a departure from the scope of the disclosure.

In operation, the system 202 may be configured to receive aviation facility data associated with the aviation facility 204. As discussed above, the aviation facility 204 may host the plurality of aerial vehicles 210. The aviation facility data may include flight schedule data associated with each aerial vehicle of the plurality of aerial vehicles 210, location data associated with the aviation facility 204, weather data associated with the aviation facility 204, layout data associated with the aviation facility 204, and air traffic data associated with the aviation facility 204.

Further, the system 202 may be configured to receive vehicle data associated with each aerial vehicle of the plurality of aerial vehicles 210. The vehicle data associated with each aerial vehicle of the plurality of aerial vehicles 210 may include a type of an aerial vehicle, a model number associated with the aerial vehicle, a dimension of the aerial vehicle, and one or more available sensors (also called the one or more sensors 212) associated with the aerial vehicle.

The system 202 may be further configured to receive the fluid data associated with the fluid 208A. The fluid 208A may correspond to a chemical solution that may be applied on the surface of the aerial vehicle such as the wings, and the tail of the aerial vehicle to remove the ice or prevent the formation of ice on the surface of the corresponding aerial vehicle. In an embodiment, the fluid 208A may be a de-icing fluid that may be used to remove the ice formed or accumulated on the surface of the aerial vehicle. In an embodiment, the fluid 208A may be an anti-icing fluid that may be used to prevent ice formation on the surface of the aerial vehicle.

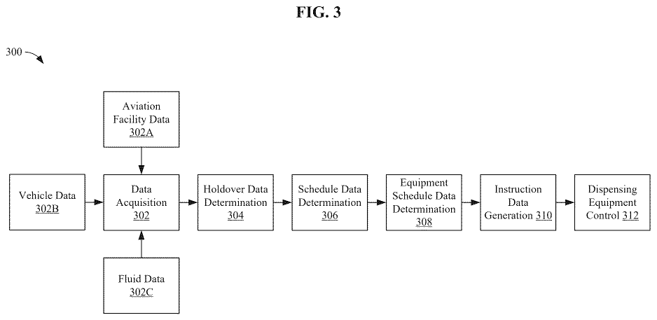

In an embodiment, the fluid data may refer to the information associated with characteristics of the fluid 208A such as, but not limited to, a chemical composition associated with the fluid 208A, a density of the fluid 208A, and a volume of the fluid 208A available within the dispensing equipment 208. Details associated with the reception of the aviation facility, the vehicle data, and the fluid data are provided, for example, in FIG. 3.

The system 202 may be further configured to apply the AI model 206 on the aviation facility data, the vehicle data, and the fluid data. Further, the system 202 may be configured to determine schedule data associated with the dispensing operation of the fluid 208A based on the application of the AI model 206 on the aviation facility data, the vehicle data, and the fluid data. The dispensing operation is performed on at least one aerial vehicle of the plurality of aerial vehicles 210. The schedule data indicates a schedule for the dispensing operation on a specific aerial vehicle of the at least one aerial vehicle. Further, the schedule data includes, but is not limited to, a start time for the dispensing operation, an end time for the dispensing operation, and one or more dispensing parameters associated with the flow of the fluid 208A on the at least one aerial vehicle. Details associated with the determination of the schedule data are provided, for example, in FIG. 3.

Thereafter, the system 202 may be configured to generate instructions data based on the schedule data and the fluid data. The instructions data includes a set of control instructions for the dispensing operation on the at least one aerial vehicle. Thereafter, the system 202 may be configured to output the instructions data. Specifically, system 202 may be configured to control the dispensing equipment 208 based on the instructions data.

Although in FIG. 1, the system 202 is associated with the aviation facility 204, the disclosure is not so limited. Accordingly, in some embodiments, the system 202 may be an entity that may be associated with an electronic device associated with the aviation facility, without deviation from the scope of the disclosure.

FIG. 3 is a block diagram that illustrates an exemplary operation for autonomous de-icing of aerial vehicles, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 312, as described herein. The exemplary operations illustrated in the block diagram 300 start at 302 and are performed by any computing system, apparatus, or device, such as by the computer 102 of FIG. 1 or the system 202 of FIG. 2. Although illustrated with discrete blocks, the exemplary operations associated with one or more blocks of the block diagram 300 are divided into additional blocks, combined into fewer blocks, or eliminated, depending on the particular implementation.

At 302, a data acquisition operation may be executed. In the data acquisition operation, the system 202 may be configured to receive the aviation facility data 302A, the vehicle data 302B, and the fluid data 302C. In an embodiment, the aviation facility data 302A, the vehicle data 302B, and the fluid data 302C may be received from the server 214. In an alternate embodiment, the aviation facility data 302A, the vehicle data 302B, and the fluid data 302C may be received from one or more data repositories associated with the aviation facility 204. In an additional embodiment, the aviation facility data 302A, the vehicle data 302B, and the fluid data 302C may be received from third party websites that may collate all the aviation facility data 302A, the vehicle data 302B, and the fluid data 302C. By way of example and not by limitation, the system 202 may receive aviation facility data 302A, the vehicle data 302B, and the fluid data 302C using one or more application programming interface (API) calls to the server 214, the one or more data repositories, or the third-party websites.

The aviation facility data 302A may be associated with the aviation facility 204 which may be useful to ensure the efficiency, and coordination of aerial vehicles in a controlled airspace or hosted on the ground. The aviation facility data 302A may be useful in ensuring efficient tracking, managing, and optimization of ground operation, thereby ensuring smooth workflow within the aviation facility 204. In an embodiment, the aviation facility data 302A includes, but is not limited to, flight schedule data associated with each aerial vehicle of the plurality of aerial vehicles 210, location data associated with the aviation facility 204, weather data associated with the aviation facility 204, layout data associated with the aviation facility 204, and air traffic data associated with the aviation facility 204.

In an embodiment, the flight schedule data associated with each aerial vehicle of the plurality of aerial vehicles 210 may include data associated with a planned as well as actual timings associated with an arrival and a departure of each aerial vehicle of the plurality of aerial vehicles 210. The flight schedule data may further include a status of the corresponding aerial vehicle for a specific airline, airport, or set of routes. The flight schedule data may further include a flight identifier (e.g. a flight number), a source and a destination of the corresponding aerial vehicle, a flight duration, terminal information associated with the landing or take-off of the aerial vehicle, and status information associated with the aerial vehicle. The flight number corresponds to a unique identifier associated with each aerial vehicle of the plurality of aerial vehicles 210. The flight duration corresponds to an estimated time the aerial vehicle may take during its journey from the source to the destination. The terminal information may include identifiers of one or more assigned terminals and gates at the aviation facility 204 for the departure and arrival of each aerial vehicle of the plurality of aerial vehicles 210. The status information associated with the aerial vehicle corresponds to the real-time status of each aerial vehicle of the plurality of aerial vehicles 210 such as “on time”, “delayed”, “canceled” or “boarding”.

The flight schedule data associated with each aerial vehicle of the plurality of aerial vehicles 210 include the duration for each aerial vehicle of the plurality of aerial vehicles 210, real-time inbound/outbound data associated with each aerial vehicle of the plurality of aerial vehicles 210, information associated with connecting flights, or any route delays associated with the aerial vehicle. The flight schedule data may be utilized to determine a ‘turn-around’ time the aerial vehicle may have from landing to its subsequent take-off. The duration time for each aerial vehicle of the plurality of aerial vehicles 210 refers to the time taken by an aerial vehicle to travel from the source to the destination. The real-time inbound/outbound data associated with each aerial vehicle of the plurality of aerial vehicles 210 may be associated with one or more aerial vehicles arriving at or departing from the aviation facility 204. For example, the inbound data may be associated with aerial vehicles arriving at the aviation facility 204. The outbound data may be associated with aerial vehicles departing from the aviation facility 204. The inbound data includes, but is not limited to, origin details of a departure airport from where the one or more aerial vehicles may be arriving, an arrival time of the one or more aerial vehicles, and navigation information to reach the aviation facility 204. The outbound data may include, but is not limited to, destination details where the one or more aerial vehicles may be departing, a departure time of the one or more aerial vehicles, and a navigation route to reach the destination. The information associated with connecting flights refers to details associated with linking flights to ensure a smooth operational process. The route delays associated with the aerial vehicle refer to real-time delays that various aerial vehicles may be experiencing on the route of the corresponding aerial vehicles.

The location data associated with the aviation facility 204 may be indicative of the geographical location of the aviation facility 204. The weather data associated with the aviation facility 204 may be real-time weather at the aviation facility 204. In an embodiment, the weather data may include environmental conditions such as, but not limited to, temperature, humidity, precipitation, wind speed, and the like at the location of the aviation facility 204. In an embodiment, the weather data associated with the aviation facility 204 includes real-time weather conditions, weather forecast data, and upper-atmospheric weather data that the plurality of aerial vehicles 210 may experience.

The layout data associated with the aviation facility 204, such as an airport or heliport, encompasses detailed information that defines the physical arrangement and design of the aviation facility 204. The layout data includes various elements, but are not limited to, runways and taxiways, which detail their dimensions, orientations, and surface materials, along with their layout and markings. The layout data also includes data about terminal buildings, such as the design and configuration of passenger terminals featuring gate areas, ticketing counters, baggage claims, and security checkpoints. Additionally, the layout data covers hangars and de-icing stations, specifying their locations and sizes for aircraft storage, maintenance, and repair.

The layout data further includes data about parking areas, detailing the arrangement of surface lots and parking garages for passengers, staff, and rental cars. The layout data further includes the positioning and structure of air traffic control towers. Furthermore, the layout data includes data about one or more support facilities, such as the de-icing stations, the fueling stations, the maintenance buildings, and the cargo terminals.

The air traffic data associated with the aviation facility 204 refers to information associated with the movement, and management of each aerial vehicle of the plurality of aerial vehicles 210 in a controlled airspace or on the ground. The air traffic data associated with aviation facility 204 includes information associated with a flow of air traffic associated with each aerial vehicle of the plurality of aerial vehicles 210. For example, the aviation facility data may be received using an application program interface (API) that offers real-time and historical aviation facility data, including aircraft information. For example, the aviation facility data may further include information associated with local regulations that the aviation facility 204, the plurality of aerial vehicles 210, and users must adhere to for safety and security purposes. This may include environmental protection, health and safety guidelines, and application standards. For example, the air traffic data may be received using air traffic control telemetry transponders, radar mode, craft types, registration, call signs, position data, altitude, speed, heading/course, navigation, and communication data.

The vehicle data 302B associated with each aerial vehicle of the plurality of aerial vehicles 210, may be utilized to track, manage, and maintain aircraft operations, baggage handling, passenger transport, and the like. The vehicle data includes for example, but is not limited to, a type of an aerial vehicle, a model number associated with the aerial vehicle, a dimension of the aerial vehicle, and one or more sensors 212 associated with the aerial vehicle.

In an embodiment, the plurality of aerial vehicles 210 may be classified into several types based on their design, mode of operation, and intended use. Different types of aerial vehicles include, but are not limited to, a fixed-wing aircraft, a rotary-wing aircraft, an unmanned aerial vehicles (UAVs), a glider, a sailplane, and an airship. Examples of different types of aerial vehicles are commercial airliners, cargo planes, private jets, military fighter jets, helicopters, space capsules, and the like.

The type of aerial vehicle further includes a unique identifier or license number associated with the aerial vehicle for vehicle identification. The vehicle data 302B may further include specifications associated with the aerial vehicle model such as a manufacturer of the aerial vehicle, a dimension of the aerial vehicle, a weight of the aerial vehicle, and technical details associated with the aerial vehicle. The vehicle data 302B further includes information associated with aerial vehicle model information, aerial vehicle registration information, and aerial vehicle operator information. The system 202 may obtain sensor data from the one or more sensors 212 associated with the aerial vehicle to receive the vehicle data.

The system 202 may be configured to receive fluid data 302C associated with the fluid 208A. As discussed above, the fluid 208A may correspond to a chemical solution to be applied on a surface of the aerial vehicle such as the wings, and the tail of the aerial vehicle. Such a fluid 208A may be utilized to remove the ice or prevent the formation of ice on the surface of the aerial vehicle. For example, the fluid 208A may be a de-icing fluid or anti-icing fluid. The de-icing fluid may be used to remove the ice formed or accumulated on the surface of the aerial vehicle. The anti-icing fluid may be used to prevent the ice formation on the surface of the aerial vehicle. The fluid data 302C may refer to the information associated with characteristics of the fluid 208A such as, but is not limited to, a chemical composition associated with the fluid 208A, a density of the fluid 208A, and a volume of the fluid 208A available within the dispensing equipment 208.

In an embodiment, the system 202 may receive fluid data 302C associated with the fluid 208A. In an embodiment, the fluid data 302C is associated with a chemical composition of the fluid 208A, a density of the fluid 208A, and a volume of the fluid 208A in the dispensing equipment 208. Further, the system 202 may leverage the use of fluid data to determine the effectiveness of the type of the fluid (such as de-icing/anti-icing fluids) or the volume of the fluid to be applied for de-icing.

At 304, a holdover data determination operation may be executed. In the holdover data determination operation, the system 202 may be configured to determine the holdover time data associated with each aerial vehicle of the plurality of aerial vehicles 210. The holdover time data may be indicative of the holdover time associated with each aerial vehicle of the plurality of aerial vehicles 210. The holdover time may refer to a duration for which the de-icing or anti-icing fluids can effectively prevent the accumulation of the ice or snow on the surface of the aerial vehicle surfaces. Specifically, the holdover time indicates a duration for which the de-icing or anti-icing fluids remains effective under a given weather condition before a reapplication of the de-icing or anti-icing fluids may be required to ensure safety of the aerial vehicle. Specifically, the holdover time corresponds to a duration during which the re-forming of the ice on the surface of the aerial vehicle may be prevented. In an embodiment, the holdover time may be influenced by several factors, including the type of fluid used, as different de-icing and anti-icing fluids have varying effectiveness. Furthermore, weather conditions also play a critical role, as the effectiveness of the fluid can be affected by temperature, precipitation type (such as snow or freezing rain), and the intensity of the precipitation, with warmer temperatures often shortening holdover time and heavy snowfall potentially overwhelming the fluid's protective capabilities. Additionally, the condition of the aircraft before fluid application, including the cleanliness of its surfaces, may also impact the holdover time, as residues or dirt may diminish the effectiveness of the fluid 208A.

In an embodiment, the system 202 may be configured to apply the AI model 206 on the aviation facility data 302A, the vehicle data 302B, and the fluid data 302C. Based on the application of the AI model 206 on the aviation facility data 302A, the vehicle data 302B, and the fluid data 302C, the system 202 may be configured to determine the holdover time data associated with each aerial vehicle of the plurality of aerial vehicles 210.

At 306, a schedule data determination operation may be performed. In the schedule data determination operation, the system 202 may be configured to determine the schedule data associated with the dispensing operation of the fluid 208A. In an embodiment of the disclosure, the system 202 may be configured to determine the schedule data associated with a dispensing operation based on the holdover time data. The system 202 may be further configured to determine the schedule data associated with the dispensing operation of the fluid 208A based on the application of the AI model 206 on the aviation facility data 302A, the vehicle data 302B, and the fluid data 302C. The dispensing operation is performed on at least one aerial vehicle of the plurality of aerial vehicles.

In an embodiment, the schedule data may indicate a schedule for prioritizing each aerial vehicle of the plurality of aerial vehicles for the de-icing process. As an example, the prioritization may be based on airline or vendor, such that a private jet may have to be de-iced before a commercial flight or vice versa. As an additional example, the de-icing may be scheduled based on the take-off time, such that the aerial vehicle with the earliest take-off time may be given priority for the de-icing process.

In an embodiment, the schedule data may indicate a schedule for sustaining a flow of the fluid for the dispensing operation on a specific aerial vehicle of the at least one aerial vehicle. The schedule data may include at least one of a start time for the dispensing operation, an end time for the dispensing operation, or one or more dispensing parameters associated with the flow of the fluid.

For example, when priority associated with the de-icing process of each aerial vehicle of the plurality of aerial vehicle 210 is fixed, the system 202 may determine the start time and the end time for the dispensing operation for each aerial vehicle of the plurality of aerial vehicle 210. Further, the one or more dispensing parameters associated with the flow of the fluid 208A may be determined for an efficient de-icing process, such as the type of the fluid 208A to be used, the volume of fluid to be sprayed, an area of the aerial vehicle to be sprayed on for de-icing, and the like. In an embodiment, the system 202 may prioritize the aerial vehicle to de-ice or anti-ice based on the holdover time such as the aerial vehicle with less holdover time may be deiced when the takeoff time for the aerial vehicle is in the near future to avoid re-de-icing of the aerial vehicle.

In an embodiment, the system 202 may be configured to receive equipment data associated with the dispensing equipment 208. In an embodiment, the equipment data may be received from the server 214. The equipment data may include aperture data associated with the dispensing equipment, and flow data associated with a flow of the fluid for the dispensing operation. The aperture data associated with the dispensing equipment 208 include dimensions of an opening or a nozzle through which the fluid 208A is expelled during the dispensing operation (also referred to as the spraying process). The flow data associated with the flow of the fluid 208A for the dispensing operation may be associated with the quantity of fluid to be sprayed by the dispensing equipment 208. Further, the system 202 may determine the schedule data based on the application of the AI model 206 on the equipment data. The schedule data may indicate a schedule for the de-icing of the aerial vehicle based on the dispensing equipment 208 and the fluid 208A available for de-icing.

At 308, equipment schedule data determination operation may be performed. In the equipment schedule data determination, the system 202 may be configured to determine equipment schedule data associated with each dispensing equipment of a plurality of dispensing equipment that may be present at the aviation facility 204. In an embodiment, the system 202 may be configured to apply the AI model 206 on the schedule data associated with the dispensing operation, the aviation facility data 302A, the vehicle data 302B, and the fluid data 302C. The system 202 may be further configured to determine the equipment schedule data associated with each dispensing equipment of the plurality of dispensing equipment based on the application of the AI model 206 on the schedule data associated with the dispensing operation, the aviation facility data 302A, the vehicle data 302B and the fluid data 302C.

At 310, an instructions data generation operation may be performed. In the instructions data generation operation, the system 202 may generate the instructions data based on the schedule data, the equipment schedule data, and the fluid data 302C. The instructions data includes a set of control instructions for the dispensing operation on the at least one aerial vehicle. The set of control instructions may include, but is not limited to, a set of navigation instructions for a navigation of the dispensing equipment 208 with respect to the at least one aerial vehicle, a set of adjustment instructions for adjusting the dispensing equipment 208 for performing the dispensing operation, and a set of operation instructions for performing the dispensing operation. In an embodiment, the dispensing equipment may correspond to an autonomous vehicle.

The set of navigation instructions for the navigation of the dispensing equipment with respect to the at least one aerial vehicle includes steering instructions for the dispensing equipment 208 to navigate from the current position of the dispensing equipment 208 within the aviation facility 204 to a location of the aerial vehicle that is to be deiced or anti-iced. In an embodiment, the set of adjustment instructions for adjusting the dispensing equipment for performing the dispensing operation includes control instructions for the dispensing equipment 208 to select a fluid to be used for de-icing or anti-icing, and time data (start and end of the dispensing operation) associated with the dispensing operation, and the like. The set of operation instructions for performing the dispensing operation includes control instructions for the dispensing equipment 208 to perform the dispensing operation, for example, a type of the fluid to be used, a volume of the fluid to be sprayed, a surface of the aerial vehicle to be sprayed with the fluid, and the like.

In an embodiment, the system 202 may be configured to generate the instructions data for each dispensing equipment of the plurality of dispensing equipment based on the equipment schedule data. For example, the equipment schedule data may include information associated with a scheduled time for each dispensing equipment of the plurality of dispensing equipment that may be present at the aviation facility 204 to perform the dispensing operation on the aerial vehicle. Based on the equipment schedule data, a schedule for each dispensing equipment may be generated for deicing each aerial vehicle that may be present at the aviation facility 204. Further, the instructions data may include a time to start the dispensing operation, the type of the fluid to be used to perform the dispensing operation, a volume of fluid to be sprayed, and the like.

In an embodiment, the selected fluid may be specific to an airport's attributes and product availability such as regulatory requirements, current temperature, predicted forecasts, environmental impacts, etc. may all be relevant attributes for consideration. For example, the deicing agent may be selected based on the temperature of the aviation facility and regulatory factors associated therewith. Such as formate based products may be utilized in eco-sensitive areas.

At 312, a dispensing equipment control operation may be executed. In the dispensing equipment control operation, the system 202 may be configured to control the dispensing equipment 208 to perform the dispensing operation. In an embodiment, the system 202 may control the dispensing equipment 208 based on the instructions data generated at 308. The dispensing equipment 208 is controlled based on the set of control instructions to perform the dispensing operation on the at least one aerial vehicle. In an embodiment, the system 202 may output the instructions data. In an embodiment, the output of the instructions data may correspond to the transmission of instructions data to the dispensing equipment 208 to perform the dispensing operation of the fluid 208A. For example, the dispensing operation may correspond to spraying of the de-icing or anti-icing fluid on the aerial vehicle.

In an embodiment, the dispensing equipment 208 may be an autonomous vehicle that may be controlled based on the instructions data to perform the de-icing of at least one aerial vehicle. In such an embodiment, the dispensing equipment 208 may be controlled to navigate the dispensing equipment 208 from the current location of the dispensing equipment 208 to a location associated with the at least one aerial vehicle. In an alternate embodiment, the dispensing equipment 208 may be a semi-autonomous vehicle including a set of robots designed to perform the dispensing operation. In such an embodiment, a user may navigate the dispensing equipment 208 from the current location of the dispensing equipment 208 to the location associated with the at least one aerial vehicle. The system 202 may instruct the dispensing equipment 208 (such as a fleet node or truck) to a specific aerial vehicle for de-icing based on the schedule data.

Therefore, the system 202 increases the efficiency of the de-icing process by leveraging the use of the AI model 206 to dynamically determine and update the schedule data associated with the dispensing operation of the fluid in a manner that the aerial vehicle is timely deiced, without any requirement of re-deicing of the aerial vehicle. Further, the system 202 may effectively monitor the aerial vehicle that is about to breach its holdover threshold. This gives system 202 greater visibility to dynamically update the schedule data based on the holdover time and various factors (such as weather data, changes in flight schedule, and the like). For example, flight A is scheduled to de-ice before a flight B. However, the take-off time for flight B is rescheduled to an early timeslot, thereby the system 202 reprioritizes the deicing schedule by deicing flight B before flight A.

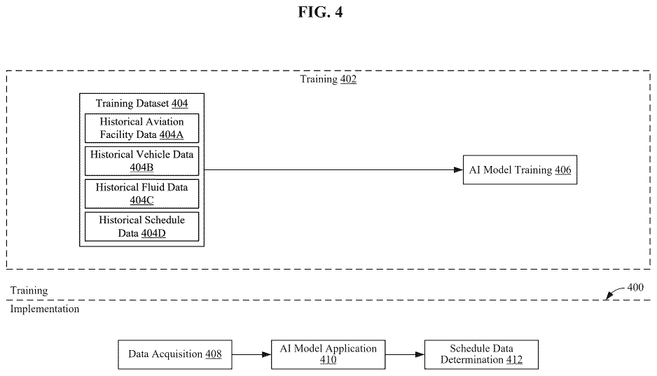

FIG. 4 is a diagram that illustrates the training of an artificial intelligence (AI) model for the determination of schedule data, in accordance with an embodiment of the disclosure. FIG. 4 is explained in conjunction with elements from FIG. 1, FIG. 2, and FIG. 3. As shown, there is a training portion above line 400 and an implementation portion below line 400. In the training portion above line 400, the system 202 receives training dataset 404. The training dataset 404 includes historical aviation facility data 404A, historical vehicle data 404B, historical fluid data 404C, and historical schedule data 404D.

The historical aviation facility data 404A may include historical flight schedule data associated with each aerial vehicle of a plurality of historical aerial vehicles hosted at one or more aviation facilities, historical location data associated with one or more aviation facilities, historical weather data associated with the one or more aviation facilities, historical layout data associated with the one or more aviation facilities, and historical air traffic data associated with the one or more aviation facilities. In an embodiment, the one or more aviation facilities may be inclusive of the aviation facility 204. In an alternative embodiment, the one or more aviation facilities may be exclusive of the aviation facility 204.

The historical vehicle data 404B is associated with the aerial vehicle of the plurality of historical aerial vehicles hosted at the one or more aviation facilities. The historical vehicle data 404B may include the type of the aerial vehicle, a model number associated with the aerial vehicle, a dimension of the aerial vehicle, and one or more available sensors associated with the aerial vehicle. The historical fluid data 404C may include a chemical composition associated with the fluid used to de-ice or anti-ice the plurality of historical aerial vehicles hosted at one or more aviation facilities, a density of the fluid used to de-ice or anti-ice the plurality of historical aerial vehicles hosted at the one or more aviation facilities, and a volume of the fluid in the dispensing equipment 208 hosted at the one or more aviation facilities.

The historical schedule data 404D may indicate a schedule for sustaining a flow of the fluid for the dispensing operation on each aerial vehicle of the plurality of historical aerial vehicles hosted at the one or more aviation facilities. The historical schedule data 404D includes at least one of a start time for the dispensing operation for de-icing or anti-icing of each aerial vehicle the plurality of historical aerial vehicles, an end time for the dispensing operation for de-icing or anti-icing of each aerial vehicle the plurality of historical aerial vehicles, or one or more dispensing parameters associated with the flow of the fluid for de-icing or anti-icing of each aerial vehicle the plurality of historical aerial vehicles.

At 406, an AI model training operation is performed. In the AI model training operation, the system 202 trains the AI model 206 based on the training dataset 404. In an embodiment of the disclosure, the system 202 provides the AI model 206 with the training dataset 404. The AI model 206 then analyzes a set of input data and a set of corresponding output data in the training dataset 404 to identify patterns and relationships between the set of input data and the set of corresponding output data. For example, the set of input data may include, but not limited to, the historical aviation facility data 404A, the historical vehicle data 404B, and the historical fluid data 404C. Further, the set of corresponding output data in the training dataset 404 may include, but not limited to, the historical schedule data 404D. Specifically, the AI model 206 determines a machine learning algorithm for determining the schedule data based on the identified patterns and relationships between the set of input data and the set of corresponding output data. The AI model 206 further utilizes the machine learning algorithm for determining the one or more schedule data based on the aviation facility data, the vehicle data, and the fluid data.

In an embodiment of the disclosure, the training 402 of the AI model 206 corresponds to the tuning of one or more hyper-parameters associated with the AI model 206 based on the training dataset 404. In an embodiment of the disclosure, the system 202 adjusts the one or more hyperparameters (the weights and the regularization parameters) of the neural network corresponding to the AI model 206 based on the identified patterns and the identified relationships between the set of input data and the set of corresponding output data in the training dataset 404 for determining the schedule data.

In an embodiment of the disclosure, the system 202 adjusts the one or more hyper-parameters of each node of the neural network corresponding to the AI model 206 based on whether the predicted output of the final layer for each input data of the set of input data (from the training dataset) matches the actual output in the corresponding output data of the set of corresponding output data. The system 202 further calculates a loss function or a training error associated with the AI model 206 based on a determination of whether the predicted output matches the actual output in the validation dataset or not. The system 202 further repeats the adjustment of one or more hyper-parameters until a minima of the loss function is achieved, or until the training error is minimized.

In the implementation portion below line 400, at 408a data acquisition operation is performed. In the data acquisition operation, the system 202 receives the aviation facility data 302A, the vehicle data 302B, and the fluid data 302C. Details about aviation facility data 302A, the vehicle data 302B, and the fluid data 302C are provided, for example, in FIG. 1 and FIG. 3.

At 410, an AI model application operation is performed. In the AI model application operation, the system 202 applies the AI model 206 on the aviation facility data 302A, the vehicle data 302B, and the fluid data 302C. The AI model 206 is trained to determine the schedule data associated with a dispensing operation of the fluid. In an embodiment of the disclosure, the AI model 206 analyzes the aviation facility data 302A, the vehicle data 302B, and the fluid data 302C and identifies the patterns and relationships based on the training dataset 404 to determine the schedule data. Details about the AI model application are provided, for example, in FIG. 2 and FIG. 3.

At 412, a schedule data determination operation is performed. In the schedule data determination operation, the system 202 determines the schedule data associated with the dispensing operation of the fluid 208A by the dispensing equipment 208. In an embodiment of the disclosure, the system 202 determines the schedule data based on the application of the AI model 206 on the aviation facility data 302A, the vehicle data 302B, and the fluid data 302C. Details about the schedule data determination are provided, for example, in FIG. 2 and FIG. 3.

In an embodiment, the system 202 may be configured to update a fluid-to-ice ratio over time to better optimize de-icing agent (or fluid volume) and to pinpoint common problem areas or anomalous ice thickness zones. Specifically, the fluid-to-ice ratio better optimizes the de-icing agent volumes by selecting an amount of deicing fluid to employ to deice or anti-ice the aerial vehicle. For example, a thin ice layer on the surface of the aerial vehicle may require a first fluid-to-ice ratio (or a first volume of fluid may be required). In an embodiment, the thin ice layer is generally defined as ice that has a thickness of up to a first thickness value (say 12 inches). In such an example, if the thickness of ice present on the wings of the aerial vehicle is 6 inches, then a first type of de-icing fluid mixed with water in a 1:1 fluid-to ice ratio (or the first fluid-to ice ratio) may be used for de-icing of the aerial vehicle. Alternatively, a thick ice layer on the surface of the aerial vehicle may require a second fluid-to-ice ratio (or a second volume of fluid may be required which may be greater than the first volume). In an embodiment, the thick ice layer is generally defined as ice that has a thickness of greater than the first thickness value (say 12 inches). In such an example, if the thickness of ice present on the wings of the aerial vehicle is 15 inches, then a second type of anti-icing fluid mixed with water in a 3:1 fluid-to ice ratio (or the second fluid-to ice ratio) may be used for melting ice from the aerial vehicle. Further, such an update of the fluid-to-ice ratio reduces operation cost of deicing by reducing excess fluid usage. This may further provide environmental sustainability by minimizing deicing chemical runoff and optimizing the usage of the fluid. In an embodiment, this may be done for training purposes by scanning the aerial vehicle at high frequencies (that may be greater than a threshold frequency) as the fluid 208A is being applied to monitor the effectiveness of the application of the fluid 208A on the plurality of aerial vehicles 210. In an embodiment, this may be performed at various temperatures, at various locations, times of day, various types of weather conditions, on various types of materials or aerial vehicles to better render initial training data and future usage techniques to be autonomously applied once learned.

Over a period of applications, the time to complete, and time remaining, found among diverse scenarios the system 202 may be suited to render “Time to Completion” estimations, which may have a significant weight in the system 202 regarding prioritization & scheduling of inbound aircraft. Additionally, this may be a field of value to be incorporated into consumer applications to make travelers aware of the de-icing process and the time remaining before takeoff.

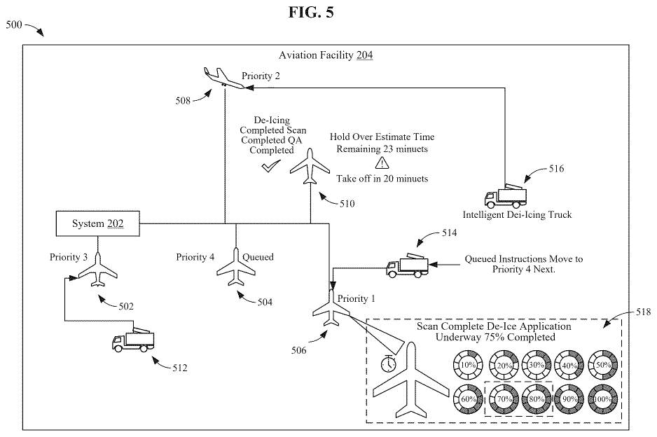

FIG. 5 is a diagram that illustrates an exemplary scenario for controlling dispensing equipment for de-icing a plurality of aerial vehicles within an aviation facility, in accordance with an embodiment of the disclosure. FIG. 5 is explained in conjunction with elements from FIG. 1, FIG. 2, FIG. 3, and FIG. 4. With reference to FIG. 5, there is shown an exemplary diagram 500 of the aviation facility 204 including the plurality of aircrafts and a plurality of trucks. The plurality of aircrafts may include, but is not limited to, a first aircraft 502, a second aircraft 504, a third aircraft 506, a fourth aircraft 508, and a fifth aircraft 510. The plurality of trucks may include, but are not limited to, a first truck 512, a second truck 514, and a third truck 516. The plurality of aircrafts may be an exemplary embodiment of the plurality of aerial vehicles 210 of FIG. 2 and each truck of the plurality of trucks may be an exemplary embodiment of the dispensing equipment 208 of FIG. 2.

In an embodiment, the system 202 receives the aviation facility data 302A associated with the aviation facility 204 and vehicle data 302B associated with each aircraft of the plurality of aircrafts such as the first aircraft 502, the second aircraft 504, the third aircraft 506, the fourth aircraft 508, and the fifth aircraft 510. The system 202 may be further configured to receive the fluid data 302C associated with the fluid 208A that may be stored in the plurality of trucks. In an embodiment, the aviation facility data 302A associated with the aviation facility 204 and vehicle data 302B associated with each aircraft of the plurality of aircrafts may indicate the takeoff time of each aircraft of the plurality of aircrafts. As a first example, the takeoff time of the first aircraft 502 maybe 47 minutes, the second aircraft 504 may be 55 minutes, the third aircraft 506 may be 33 minutes, the fourth aircraft 508 may be 40 minutes, and the fifth aircraft 510 may be 20 minutes.

Thereafter, the system 202 may be configured to apply the AI model 206 on the aviation facility data 302A, the vehicle data 302B, and the fluid data 302C. Based on the application of the AI model 206 on the aviation facility data 302A, the vehicle data 302B, and the fluid data 302C, the system 202 may be configured to determine a holdover time associated with each aircraft of the plurality of aircrafts. With reference to the first example, the holdover time associated with each aircraft may be the same (say 23 minutes).

The system 202 may be further configured to determine the schedule data associated with the dispensing operation of the fluid on each aircraft of the plurality of aircrafts. The schedule data may indicate a schedule in which each aircraft of the plurality of aircrafts may be anti-iced or de-iced. In an embodiment, the schedule data may be determined based on the takeoff time of each aircraft. In an embodiment, the generated schedule data may indicate a sequence in which the plurality of aircrafts may de-iced or anti-iced. With reference to the first example, the sequence may indicate the fifth aircraft 510 may be de-iced or anti-iced initially (as the takeoff time of the fifth aircraft 510 is 20 minutes), then the third aircraft 506 may be de-iced or anti-iced. After the third aircraft 506, the fourth aircraft 508 may be de-iced or anti-iced initially. After the fourth aircraft 508, the first aircraft 502 may de-iced or anti-iced. Finally, the second aircraft 504 may be de-iced or anti-iced.

Thereafter, the system 202 may generate the instructions data to control the first truck 512, the second truck 514, and the third truck 516 for performing the de-icing process of the plurality of aircrafts. With reference to the first example, the first truck 512 may be controlled to perform the dispensing operation on the fifth aircraft 510. The second truck 514 may be controlled to perform the dispensing operation on the third aircraft 506. Thereafter, the third truck 516 may be controlled to perform the dispensing operation on the fourth aircraft 508. Further, the first truck 512 may be queued to perform the dispensing operation on the first aircraft 502 for the de-icing. Furthermore, the second truck 514 may be queued to move to the next aircraft in the priority (such as the second aircraft 504) for the de-icing.

Further, the system 202 may initiate the de-icing process for the fifth aircraft 510 and determine the schedule data for the remaining aerial vehicles (such as the first aircraft 502, the second aircraft 504, the third aircraft 506, and the fourth aircraft 508). For example, when the de-icing process is completed for the fifth aircraft 510, the system 202 may perform a complete scan for quality assurance of the fifth aircraft 510 for takeoff. In an embodiment, the system 202 may be configured to scan the fifth aircraft 510 using the one or more sensors to ensure that the fifth aircraft 510 is completely de-iced or anti-iced which further ensures safe takeoff and landing of the fifth aircraft 510. Further, the system 202 may prioritize the third aircraft 506, the fourth aircraft 508, the first aircraft 502, and the second aircraft 504 based on the generated schedule data as per the takeoff time associated with the corresponding aircraft.

As discussed above, the plurality of dispensing equipment may correspond to a fleet of manually driven and/or autonomous vehicles that may be equipped with a boom/robotic arm within a pressure-based system that deploys de-icing or anti-icing fluids such as glycol chemical on the plurality of aircrafts. With this context, the system 202 may analyze the likelihood of ice formations on the aerial vehicles either arriving from icy conditions such as specific paths in the upper atmosphere or through more localized events such as ice accumulations at ground level at the airport.

In an embodiment, the plurality of aircrafts or the plurality of trucks may be equipped with specialized sensors that perform scans that identify ice formations/accumulation and record the correlating historical data granularized to specific aerial vehicle types and previous trip logs. In an embodiment, the system 202 retrieves aerial vehicle specifications via one or more API calls to the server 214, therefore the system 202 receives information associated with the height, length, and ice accumulation severity, and can render a percentage of completion of the de-icing agent application process based on historical data in similar conditions, temperature, aerial vehicle, etc. This information helps the system 202 better prioritize and create efficiency gains in airport operations by leveraging the use of the data-driven aviation system management platform to influence factors such as inclement weather, external up/downstream schedule disruptions, schedule delays, re-routed aircraft, mishaps & emergency scenarios, etc. to manage and optimize the most efficient in/out de-ice prioritization means.

In an embodiment, the system 202 may receive sensor data from the one or more sensors 212. Each sensor of the one or more sensors 212 may be associated with the at least one aerial vehicle. Using the one or more sensors 212 such as optical, thermal imaging, lidar, infrared, or means and/or a combination of data collection/sensors may be leveraged to quantify the ice accumulation or thickness of ice/snow on the aerial vehicle. Using this data in correlations with ground and/or upper atmospheric weather data, the system 202 may be configured to select the fluid (also called de-icing liquid) such as glycol-based products. Since the glycol-based products may be effective in deicing in extremely cold temperatures.

In an embodiment, the system 202 may generate status data based on the sensor data. The status data may be indicative of a status of the dispensing operation. For example, the one or more sensors 212 may be implemented in the plurality of aircrafts or the plurality of trucks to determine the status of completion of the dispensing operation (or the de-icing operation) on the corresponding aircraft. For example, different sensors may be implemented to determine how thick or thin the ice is on the surface of the aerial vehicle. The system 202 may be further configured to display the status on a display screen associated with the system 202.

In an embodiment, the one or more sensors 212 may be used to identify ice on the surface of the aerial vehicle. For example, the system 202 uses the imaging sensors on the boom of the aerial vehicle, or the robotic arm of dispensing equipment 208 to capture the sensor data. The status data is associated with the dispensing operation of the fluid 208A from the dispensing equipment 208 on the at least one aerial vehicle and outputs the status data. In an embodiment, the system 202 may render a percentage of completion of the dispensing process on a user interface 518 associated with the system 202. Furthermore, the system 202 may render time to complete the deicing operation, time remaining in the deicing operation and status data associated with the deicing operation, thereby displaying prioritization and scheduling of inbound aerial vehicles on the user interface 518. Additionally, the status data may be a field of value that may be incorporated into consumer applications to make travelers aware of the de-icing process and the time remaining before take-off.

In an embodiment, the system 202 may be configured to manage the plurality of the trucks. In an embodiment, the system 202 may leverage the use of AI model 206 to determine the equipment schedule data associated with each dispensing equipment of the plurality of dispensing equipment. The equipment schedule data is determined based on the application of the AI model 206 on the schedule data associated with the dispensing operation, the aviation facility data 302A, the vehicle data 302B, and the fluid data 302C. Further, the system 202 may generate the instructions data for each dispensing equipment of the plurality of dispensing equipment based on the equipment schedule data.

In an embodiment, the system 202 may be configured to determine the availability of the dispensing equipment proximal to the target aerial vehicle to avoid collision between the aerial vehicle and the dispensing equipment using one or more proximity sensors. Further, the system incorporates proximity detection in the de-icing equipment in correlation to the aerial vehicle, thereby avoiding collision and providing autonomous application of the de-icing fluid. Therefore, the disclosed system 202 features an autonomous means for the de-icing equipment to queue tasks based on tailored priority attributes, thereby ensuring data-driven surface coverage, ice detection, and environmental variables to better leverage glycol-based de-icing volumes and application usage on identified aerial vehicle target areas.

The system 202 may be customized & tailored based on a plurality of factors such as the location data associated with the aviation facility 204, the availability of the dispensing equipment 208, capabilities of the dispensing equipment 208, one or more regional regulations, the capacity of the dispensing equipment 208, and the layout data of the aviation facility 204. Furthermore, the system 202 is adaptable based on available sensor types, the accuracy of available systems, cost considerations, and the complexity desired ranging from a simplistic to an advanced technical solution. The system 202 may be deployed to various vehicle types such as traditional trucks, and autonomous vehicles, using robotic arms, booms, stationary platforms, pressure-based wash systems, or any logical terrestrial integration.

In an embodiment, the system 202 may identify inbound/outbound flights for the day and recognize weather conditions in real-time via the API calls to the server 214. With this context, the system 202 may analyze the likelihood of ice formations on one or more aerial vehicles either arriving from icy conditions such as specific paths in the upper atmosphere, or through more localized events such as ice accumulations at ground level on the airport tarmac. With a probability of ice accumulations and correlating treatments to mitigate accidents, with such data, the system 202 may deploy the plurality of dispensing equipment to perform the dispensing operation on the one or more aerial vehicles. As discussed above, the plurality of dispensing equipment may be equipped with specialized sensors that perform scans that identify ice formations/accumulation and record the correlating historical data granularized to specific aerial vehicle types and previous trip logs. During the dispensing operation, the system 202 may have access to aerial vehicle specifications via API, therefore the system 202 knows the height, length, and ice accumulation severity. The system 202 may render a complete percentage of the de-icing agent application process based on historical records in similar conditions, temperature, aerial vehicle, etc. This information helps the system better prioritize and create efficiency gains in airport operations.

In an embodiment, the system 202 may generate the schedule data based on the First in First Out (FIFO) approach for inbound/outbound flights, such that the first aerial vehicle that lands first is prioritized higher than the remaining aerial vehicles, and every plane thereafter is maintained in sequential order of landing, and the first to leave is scanned/addressed as priority for outbound traffic. In an embodiment, the schedule data may be determined based on a specific aerial vehicle's ETA (estimated time of arrival), Grounded Time, and ETD (departure) are factored in among a plurality of competing aerial vehicles using the same considerations. This may optimize airport traffic and reduce departure delays.

In an embodiment, the de-icing fleet or truck (the dispensing equipment 208) may leverage time series analysis for handling weather data and scheduling data, which may be time-dependent. In an embodiment, Long Short-Term Memory (LSTM) networks may be implemented within the AI model 206. The LSTM network may be used to capture temporal dependencies in the data. The AI model 206 may predict how weather changes might affect an aerial vehicle's ice accumulations and/or flight path status state over time or how the scheduling data impacts its evaluation across a multitude of decisions. Further, the training of the AI model 206 may be required in this regard and should be fine-tuned or continually managed for proper optimization.

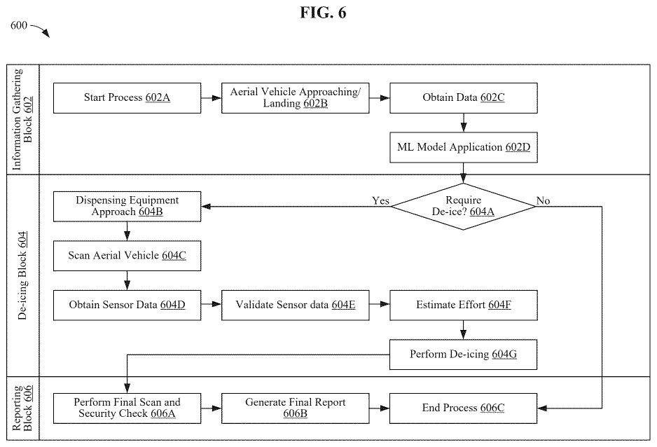

FIG. 6 is a block diagram that illustrates exemplary operations for autonomous de-icing of aerial vehicles, in accordance with an embodiment of the disclosure. FIG. 6 is explained in conjunction with elements from FIG. 1, FIG. 2, FIG. 3, FIG. 4, and FIG. 5. With reference to FIG. 6, there is shown block diagram 600. The operations of the exemplary method are executed by any computing system, for example, by the computer 102 of FIG. 1 or the system 202 of FIG. 2. The block diagram 600 may be divided into an information gathering block 602, a de-icing block 604, and a reporting block 606. The operations may start in the information gathering block 602 at 602A.

At 602B, an aerial vehicle may approach or land at the aviation facility 204. At 602C, the system 202 may obtain the vehicle data associated with the approaching or the landed aerial vehicle. In an embodiment, the vehicle data may include a type of an aerial vehicle, a model number associated with the aerial vehicle, a dimension of the aerial vehicle, and one or more sensors associated with the aerial vehicle. Further, the system 202 may apply the AI model 206 on the aviation facility data associated with an aviation facility 204 and the vehicle data at 602D.

Thereafter, at 604A, the system 202 determines whether deicing of the aerial vehicle is required or not based on the application of the AI model 206 on the aviation facility data 302A associated with an aviation facility 204 and the vehicle data 302B. If the deicing is not required, the flow may be transferred to 606C. If the deicing is required, the system 202 may transmit the instructions data to the deicing equipment to approach the aerial vehicle, at 604B, to perform the deicing operation. Further, at 604C, the system 202 may scan the aerial vehicle to obtain the sensor data at 604D and validate the sensor data to generate the set of control instructions for the dispensing operation on the at least one aerial vehicle at 604E. For example, the set of control instructions regarding the surface of the aerial vehicle to be de-iced, the type of the fluid to be used, and the time required to complete the deicing process. Once the instructions data is generated, the system 202 may estimate the effort (or time required to de-ice the aerial vehicle and the volume of fluid required to de-ice the aerial vehicle) at 604F. The system 202 may control the deicing equipment to perform the deicing operation at 604G. Thereafter performing the deicing operation at 604G, a final scan of the aerial vehicle may be performed by the system 202 at 606A to ensure complete deicing of the aerial vehicle, thereby providing safe landing and takeoff of the aerial vehicle. Further, a final report may be generated at 606B to provide a status update on the completion of the deicing process. The operations may end at 606C.

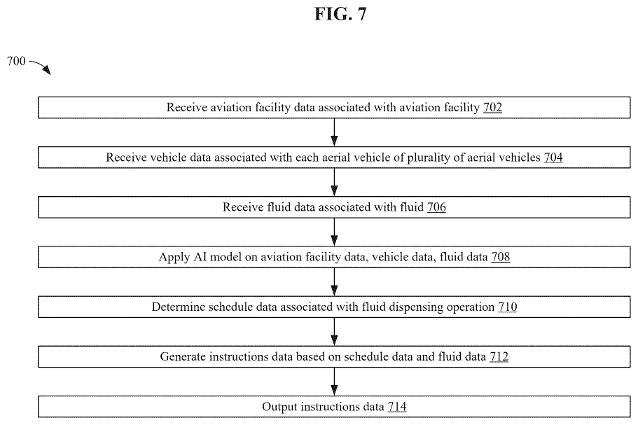

FIG. 7 is a diagram that illustrates a flow chart of an exemplary method for generating the instructions data for performing the dispensing operation, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown flowchart 700. The operations of the exemplary method are executed by any computing system, for example, by the computer 102 of FIG. 1 or the system 202 of FIG. 2. The operations of the flowchart 700 may start at 702.

At 702, aviation facility data associated with an aviation facility 204 may be received. In an embodiment of the disclosure, the system 202 is configured to receive the aviation facility data 302A associated with the aviation facility 204. The aviation facility 204 is associated with the plurality of aerial vehicles 210. The aviation facility data 302A includes flight schedule data associated with each aerial vehicle of the plurality of aerial vehicles 210, location data associated with the aviation facility 204, weather data associated with the aviation facility 204, layout data associated with the aviation facility 204, and air traffic data associated with the aviation facility 204. Details associated with the reception of the aviation facility data are provided, for example, in FIG. 2 and FIG. 3.

At 704, the vehicle data 302B associated with each aerial vehicle of the plurality of aerial vehicles 210 may be received. In an embodiment of the disclosure, the system 202 is configured to receive the vehicle data 302B associated with each aerial vehicle of the plurality of aerial vehicles 210. The vehicle data 302B includes a type of an aerial vehicle, a model number associated with the aerial vehicle, a dimension of the aerial vehicle, and one or more available sensors associated with the aerial vehicle. Details associated with the reception of the vehicle data 302B are provided, for example, in FIG. 3.

At 706, the fluid data 302C associated with the fluid may be received. In an embodiment of the disclosure, the system 202 is configured to receive the fluid data 302C associated with the fluid 208A. The fluid data 302C includes a chemical composition associated with the fluid 208A, a density of the fluid 208A, and a volume of the fluid 208A available within the dispensing equipment 208. Details associated with the reception of the fluid data 302C are provided, for example, in FIG. 3.

At 708, the AI model 206 may be applied on the aviation facility data 302A, the vehicle data 302B, and the fluid data 302C. In an embodiment of the disclosure, the system 202 is configured to apply the AI model 206 on the aviation facility data 302A, the vehicle data 302B, and the fluid data 302C. Details about the application of the AI model 206 are provided, for example, in FIG. 3.

At 710, schedule data associated with a dispensing operation may be determined. In an embodiment of the disclosure, the system 202 is configured to determine the schedule data associated with the fluid dispensing operation. The dispensing operation is performed on at least one aerial vehicle of the plurality of aerial vehicles 210. The schedule data is determined based on the application of the AI model 206 on the aviation facility data 302A, the vehicle data 302B, and the fluid data 302C. Further, the schedule data indicates a schedule for sustaining a flow of the fluid for the dispensing operation on a specific aerial vehicle of the at least one aerial vehicle. The schedule data includes at least one of a start time for the fluid dispensing operation, an end time for the fluid dispensing operation, or one or more dispensing parameters associated with the flow of the fluid. Details associated with the determination of the schedule data are provided, for example, in FIG. 3, FIG. 4, and FIG. 5.

At 712, instructions data may be generated. In an embodiment of the disclosure, the system 202 is configured to generate the instructions data based on the schedule data and the fluid data 302C. The instructions data includes a set of control instructions for the dispensing operation on the at least one aerial vehicle. Details associated with the generation of the instructions data are described, for example, in FIG. 3 and FIG. 4.

At 714, the instructions data may be outputted. In an embodiment of the disclosure, the system 202 is configured to output the instructions data. Further, the dispensing equipment 208 is controlled based on the instructions data. The dispensing equipment 208 is controlled based on the set of control instructions to perform the dispensing operation on the at least one aerial vehicle. Details associated with the generation of the instructions data are described, for example, in FIG. 3 and FIG. 4.

While the above steps shown in FIG. 7 are described in a particular sequence, the steps may occur in variations to the sequence in accordance with various embodiments of the present disclosure. Further, details related to various steps of FIG. 7 which are already covered in the description related to FIG. 1, FIG. 2, FIG. 3, FIG. 4, FIG. 5, and FIG. 6, are not discussed again in detail here for the sake of brevity.

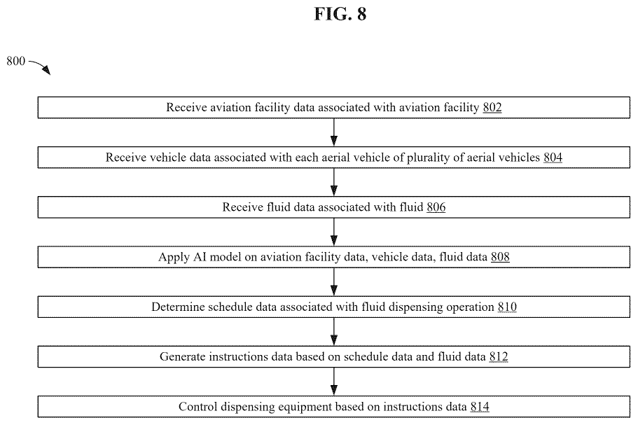

FIG. 8 is a diagram that illustrates a flow chart of an exemplary method for autonomous de-icing of aerial vehicles, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown flowchart 800. The operations of the exemplary method are executed by any computing system, for example, by the computer 102 of FIG. 1 or the system 202 of FIG. 2. The operations of the flowchart 800 may start at 802.

At 802, the aviation facility data 302A associated with an aviation facility 204 may be received. In an embodiment of the disclosure, the system 202 is configured to receive the aviation facility data 302A associated with the aviation facility 204. The aviation facility 204 is associated with the plurality of aerial vehicles 210. The aviation facility data 302A includes flight schedule data associated with each aerial vehicle of the plurality of aerial vehicles 210, location data associated with the aviation facility 204, weather data associated with the aviation facility 204, layout data associated with the aviation facility 204, and air traffic data associated with the aviation facility 204. Details associated with the reception of the aviation facility data 302A are provided, for example, in FIG. 1 and FIG. 3.

At 804, the vehicle data 302B associated with each aerial vehicle of the plurality of aerial vehicles 210 may be received. In an embodiment of the disclosure, the system 202 is configured to receive the vehicle data 302B associated with each aerial vehicle of the plurality of aerial vehicles 210. The vehicle data 302B includes a type of an aerial vehicle, a model number associated with the aerial vehicle, a dimension of the aerial vehicle, and one or more available sensors associated with the aerial vehicle. Details associated with the reception of the vehicle data are provided, for example, in FIG. 3.

At 806, fluid data associated with the fluid may be received. In an embodiment of the disclosure, the system 202 is configured to receive the fluid data associated with the fluid. The fluid data includes a chemical composition associated with the fluid, a density of the fluid, and a volume of the fluid available within the dispensing equipment 208. Details associated with the reception of the fluid data are described, for example, in FIG. 3.

At 808, AI model 206 may be applied on the aviation facility data 302A, the vehicle data 302B, and the fluid data 302C. In an embodiment of the disclosure, the system 202 is configured to apply the AI model 206 on the aviation facility data 302A, the vehicle data 302B, and the fluid data 302C. Details about the application of the AI model 206 are provided, for example, in FIG. 3.

At 810, the schedule data associated with a dispensing operation may be determined. In an embodiment of the disclosure, the system 202 is configured to determine the schedule data associated with the fluid dispensing operation. The dispensing operation is performed on at least one aerial vehicle of the plurality of aerial vehicles 210. The schedule data is determined based on the application of the AI model 206 on the aviation facility data, the vehicle data, and the fluid data. Further, the schedule data indicates a schedule for sustaining a flow of the fluid for the dispensing operation on a specific aerial vehicle of the at least one aerial vehicle. The schedule data includes at least one of a start time for the fluid dispensing operation, an end time for the fluid dispensing operation, or one or more dispensing parameters associated with the flow of the fluid. Details associated with the determination of the schedule data are described, for example, in FIG. 3 and FIG. 4.

At 812, the instructions data may be generated. In an embodiment of the disclosure, the system 202 is configured to generate the instructions data based on the schedule data and the fluid data 302C. The instructions data includes the set of control instructions for the dispensing operation on the at least one aerial vehicle. Details associated with the generation of the instructions data are provided, for example, in FIG. 3 and FIG. 4.

At 814, the dispensing equipment 208 may be controlled. In an embodiment of the disclosure, the system 202 is configured to control the dispensing equipment 208 based on the instructions data. The dispensing equipment 208 is controlled based on the set of control instructions to perform the dispensing operation on the at least one aerial vehicle. Details associated with the generation of the instructions data are provided, for example, in FIG. 3 and FIG. 4.

While the above steps shown in FIG. 8 are described in a particular sequence, the steps may occur in variations to the sequence in accordance with various embodiments of the present disclosure. Further, details related to various steps of FIG. 8 which are already covered in the description related to FIG. 1, FIG. 2, FIG. 3, FIG. 4, FIG. 5, FIG. 6, and FIG. 7 are not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, aviation facility data associated with an aviation facility, wherein the aviation facility is associated with a plurality of aerial vehicles;
receiving, by the computer, vehicle data associated with each aerial vehicle of the plurality of aerial vehicles;
receiving, by the computer, fluid data associated with a fluid;
applying, by the computer, an artificial intelligence (AI) model on the aviation facility data, the vehicle data, and the fluid data;
determining, by the computer, schedule data associated with a dispensing operation of the fluid, wherein the schedule data is determined based on the application of the AI model on the aviation facility data, the vehicle data, and the fluid data, and wherein the dispensing operation is performed on at least one aerial vehicle of the plurality of aerial vehicles;
generating, by the computer, instructions data based on the schedule data and the fluid data, wherein the instructions data comprises a set of control instructions for the dispensing operation on the at least one aerial vehicle; and
outputting, by the computer, the instructions data.

2. The computer-implemented method of claim 1, wherein the aviation facility data comprises flight schedule data associated with each aerial vehicle of the plurality of aerial vehicles, location data associated with the aviation facility, weather data associated with the aviation facility, layout data associated with the aviation facility, and air traffic data associated with the aviation facility.

3. The computer-implemented method of claim 1, further comprising:
determining, by the computer, holdover time data associated with each aerial vehicle of the plurality of aerial vehicles based on the application of the AI model on the aviation facility data, the vehicle data, and the fluid data; and
determining, by the computer, the schedule data associated with the dispensing operation based on the holdover time data.

4. The computer-implemented method of claim 1, further comprising controlling, by the computer, a dispensing equipment based on the instructions data.

5. The computer-implemented method of claim 4, wherein
the dispensing equipment is an autonomous vehicle, and
the set of control instructions comprises at least one of a set of navigation instructions for a navigation of the dispensing equipment with respect to the at least one aerial vehicle, a set of adjustment instructions for adjusting the dispensing equipment for the performing the dispensing operation, or a set of operation instructions for performing the dispensing operation.

6. The computer-implemented method of claim 4, further comprising:
receiving, by the computer, equipment data associated with the dispensing equipment, wherein the equipment data comprises:
aperture data associated with the dispensing equipment, and
flow data associated with a flow of the fluid for the dispensing operation;
applying, by the computer, the AI model on the equipment data; and
determining, by the computer, the schedule data based on the application of the AI model on the equipment data.

7. The computer-implemented method of claim 4, further comprising:
receiving, by the computer, sensor data from one or more sensors, wherein each sensor of the one or more sensors is associated with the at least one aerial vehicle;
generating, by the computer, status data based on the sensor data, wherein the status data is associated with the dispensing operation of the fluid from the dispensing equipment on the at least one aerial vehicle; and
outputting, by the computer, the status data.

8. The computer-implemented method of claim 4, wherein the fluid data comprises a chemical composition associated with the fluid, a density of the fluid, and a volume of the fluid in the dispensing equipment.

9. The computer-implemented method of claim 1, wherein the vehicle data associated with each aerial vehicle of the plurality of aerial vehicles comprises a type of an aerial vehicle, a model number associated with the aerial vehicle, a dimension of the aerial vehicle, and one or more sensors associated with the aerial vehicle.

10. The computer-implemented method of claim 1, wherein the aviation facility is associated with a plurality of dispensing equipment, and wherein the method further comprises:
applying, by the computer, the AI model on the schedule data associated with the dispensing operation, the aviation facility data, the vehicle data, and the fluid data;
determining, by the computer, equipment schedule data associated with each dispensing equipment of the plurality of dispensing equipment based on the application of the AI model on the schedule data associated with the dispensing operation, the aviation facility data, the vehicle data, and the fluid data; and
generating, by the computer, the instructions data for each dispensing equipment of the plurality of dispensing equipment based on the equipment schedule data.

11. The computer-implemented method of claim 1, further comprising:
receiving, by the computer, training dataset comprising historical vehicle data, historical aviation facility data, historical fluid data, and historical schedule data;
training, by the computer, the AI model based on the training dataset;
applying, by the computer, the trained AI model on the aviation facility data, the vehicle data, and the fluid data; and
determining, by the computer, the schedule data associated with the dispensing operation based on the application of the trained AI model on the aviation facility data, the vehicle data, and the fluid data.

12. The computer-implemented method of claim 1, wherein
the schedule data indicates a schedule for sustaining a flow of the fluid for the dispensing operation on a specific aerial vehicle of the at least one aerial vehicle, and
the schedule data comprises at least one of a start time for the dispensing operation, an end time for the dispensing operation, or one or more dispensing parameters associated with the flow of the fluid.

13. A computer system, comprising:
a processor set;
one or more computer-readable storage media; and
program instructions stored on the one or more computer-readable storage media, the program instructions executable by the processor set to cause the processor set to:
receive aviation facility data associated with an aviation facility, wherein the aviation facility is associated with a plurality of aerial vehicles;
receive vehicle data associated with each aerial vehicle of the plurality of aerial vehicles;
receive fluid data associated with a fluid;
apply an artificial intelligence (AI) model on the aviation facility data, the vehicle data, and the fluid data;
determine schedule data associated with a dispensing operation of the fluid, wherein the schedule data is determined based on the application of the AI model on the aviation facility data, the vehicle data, and the fluid data, and wherein the dispensing operation is performed on at least one aerial vehicle of the plurality of aerial vehicles;
generate instructions data based on the schedule data and the fluid data, wherein the instructions data comprises a set of control instructions for the dispensing operation on the at least one aerial vehicle; and
control a dispensing equipment based on the instructions data, wherein the dispensing equipment is controlled based on the set of control instructions to perform the dispensing operation on the at least one aerial vehicle.

14. The computer system of claim 13, wherein the aviation facility data comprises flight schedule data associated with each aerial vehicle of the plurality of aerial vehicles, location data associated with the aviation facility, weather data associated with the aviation facility, layout data associated with the aviation facility, and air traffic data associated with the aviation facility.

15. The computer system of claim 13, wherein the program instructions further cause the processor set to:
determine holdover time data associated with each aerial vehicle of the plurality of aerial vehicles based on the application of the AI model on the aviation facility data, the vehicle data, and the fluid data; and
determine the schedule data associated with the dispensing operation based on the holdover time data.

16. The computer system of claim 13, wherein
the dispensing equipment is an autonomous vehicle, and
the set of control instructions comprises at least one of a set of navigation instructions for a navigation of the dispensing equipment with respect to the at least one aerial vehicle, a set of adjustment instructions to adjust the dispensing equipment for the performing the dispensing operation, or a set of operation instructions for performing the dispensing operation.

17. The computer system of claim 13, wherein the program instructions further cause the processor set to:
receive equipment data associated with the dispensing equipment, wherein the equipment data comprises aperture data associated with the dispensing equipment and flow data associated with a flow of the fluid for the dispensing operation;
applying, by the computer, the AI model on the equipment data; and
determine the schedule data based on the application of the AI model on the equipment data.

18. The computer system of claim 13, wherein the program instructions further cause the processor set to:
receive sensor data from one or more sensors, wherein each sensor of the one or more sensors is associated with the at least one aerial vehicle;
generate status data based on the sensor data, wherein the status data is associated with the dispensing operation of the fluid from the dispensing equipment on the at least one aerial vehicle; and
output the status data.

19. The computer system of claim 13, wherein the aviation facility is associated with a plurality of dispensing equipment, and wherein the program instructions further cause the processor set to:
apply an artificial intelligence (AI) model on the schedule data associated with the dispensing operation, the aviation facility data, the vehicle data, and the fluid data;
determine equipment schedule data associated with each dispensing equipment of the plurality of dispensing equipment based on the application of the AI model on the schedule data associated with the dispensing operation, the aviation facility data, the vehicle data, and the fluid data; and
generate the instructions data for each dispensing equipment of the plurality of dispensing equipment based on the equipment schedule data.

20. A computer-program product for generating instructions data for performing a dispensing operation, the computer-program product comprising:
one or more computer-readable storage media; and
program instructions stored on the one or more computer-readable storage media to perform operations comprising:
receiving aviation facility data associated with an aviation facility, wherein the aviation facility is associated with a plurality of aerial vehicles;
receiving vehicle data associated with each aerial vehicle of the plurality of aerial vehicles;
receiving fluid data associated with a fluid;
applying an artificial intelligence (AI) model on the aviation facility data, the vehicle data, and the fluid data;
determining schedule data associated with the dispensing operation of the fluid, wherein the schedule data is determined based on an application of the AI model on the aviation facility data, the vehicle data, and the fluid data, and wherein the dispensing operation is performed on at least one aerial vehicle of the plurality of aerial vehicles;
generating the instructions data based on the schedule data and the fluid data, wherein the instructions data comprises a set of control instructions for the dispensing operation on the at least one aerial vehicle; and
outputting the instructions data.
